(19) United States
(12) Patent Application Publication
(10) Pub. No.: US 2015/0066259 A1
(43) Pub. Date: Mar. 5, 2015

(54) Engine Oil Maintenance Monitor For A Hybrid Electric Vehicle

(71) Applicant: Ford Global Technologies, LLC, Dearborn, MI (US)

(72) Inventor: Scott James Thompson, Waterford, MI (US)

(73) Assignee: Ford Global Technologies, LLC, Dearborn, MI (US)

(21) Appl. No.: 14/013,913

(22) Filed: Aug. 29, 2013

(51) Int. Cl. F01M 1/14; F01M 1/18; B60W 10/08; F01M 1/02; B60W 20/00; B60W 10/06

(52) U.S. Cl. CPC F01M 1/14; B60W 20/40; B60W 10/06; B60W 10/08; F01M 1/02; F01M 1/18; Y10S 903/93; F01M 2001/0269
USPC 701/22; 180/65.265; 903/930

(57) ABSTRACT

A hybrid vehicle is provided with an engine having a crankshaft and an electric machine coupled to the crankshaft. The hybrid vehicle also includes a pump and a controller. The pump is driven by rotation of the crankshaft and coupled to the engine by a fluid circuit. The controller is configured to control the electric machine in response to a wheel torque request to drive the crankshaft with the engine off to provide lubricant to the engine.

### TECHNICAL FIELD

One or more embodiments relate to an engine oil maintenance monitor for monitoring the quantity and quality of oil within an engine of a hybrid electric vehicle.

### BACKGROUND

A hybrid electric vehicle (HEV) includes an internal combustion engine and one or more electric machines, wherein the energy source for the engine is fuel and the energy source for the electric machine may be electrical energy from a battery and/or electrical energy that is converted from the engine. In a HEV, the engine is the main source of energy for vehicle propulsion and the battery provides supplemental energy. A PHEV is like a HEV, but the PHEV has a larger capacity battery that is rechargeable from the external electric grid. In a PHEV, the battery is the main source of energy for vehicle propulsion during an electric vehicle (EV) mode, until the battery depletes to a low energy level, at which time the PHEV operates like a HEV for vehicle propulsion. The PHEV may operate for long periods of time using only battery power, for example, when the PHEV is used for shorter commutes, trips, and the like. The battery is recharged between these trips using a charging station and does not reach a state of charge where engine power is required to propel the vehicle.

The engine is started or stopped each time the powertrain transitions between a HEV mode and an EV mode. The engine, as in the case of conventional powertrain systems, requires a lubrication oil pump, which typically is driven by the engine as lubricating oil is circulated from an engine oil sump through moving components within the engine block. The oil is then drained back to the oil sump. In a HEV of the type described above, frequent engine stops and starts will reduce fuel consumption, but before each start there is a low oil pressure in the lubrication system. In a PHEV, infrequent restarts of the engine may result in much of the engine oil draining into the oil sump. Restarting the engine when there is insufficient engine oil can increase engine wear due to thin oil films on surfaces between relatively movable elements of the engine, which potentially affects engine life. Therefore, many HEVs and PHEVs include a secondary engine oil pump that is electrically powered (electric oil pump) to supplement the engine driven oil pump (mechanical oil pump) during the EV mode. However, such a dual oil pump system is redundant, and adds cost and weight to a HEV.

Additionally, for a PHEV, the engine oil quality may degrade or become stale during these periods of time when the vehicle is operating using primarily battery power. In some instances, this may lead to oil degradation such as water formation in the oil, and the like.

In HEVs and PHEVs the vehicle braking may include friction braking, regenerative braking and engine braking. The term engine braking usually refers to the braking effect caused by the closed-throttle partial-vacuum in petrol (gasoline) engines when the accelerator pedal is released.

Diesel engines do not have engine braking in the above sense. Unlike petrol engines, diesel engines vary fuel flow to control power rather than throttling air intake and maintaining a constant fuel ratio as petrol engines do. As they do not maintain a throttle vacuum, they are not subjected to the same engine braking effects. However, some alternative mechanisms which diesel engines use that replace or simulate real engine braking include: a compression release brake, or jake brake. A jake brake is used mainly in large diesel trucks and works by opening the exhaust valves at the top of the compression stroke, resulting in adiabatic expansion of the compressed air, so the large amount of energy stored in that compressed air is not returned to the crankshaft, but is released into the atmosphere. This type of brake is banned or restricted in many locations where people live because it creates loud objectionable sound.

### SUMMARY

In one or more embodiments, a hybrid vehicle is provided with an engine having a crankshaft and an electric machine coupled to the crankshaft. The hybrid vehicle also includes a pump and a controller. The pump is driven by rotation of the crankshaft and coupled to the engine by a fluid circuit. The controller is configured to control the electric machine in response to a wheel torque request to drive the crankshaft with the engine off to provide lubricant to the engine.

In another embodiment, a method is provided for providing lubrication fluid to an engine in a hybrid vehicle. The fuel provided to an engine is disabled. An electric machine is controlled to drive a crankshaft of the engine and a pump coupled to the crankshaft in response to a wheel torque request exceeding an available regenerative braking torque, wherein the pump is coupled to the engine for providing lubrication fluid.

In yet another embodiment a vehicle system is provide with a pump and a controller. The pump is coupled to a crankshaft of an engine to provide lubricant thereto in response to rotation of the crankshaft. The controller is configured to control an electric machine to drive the crankshaft with the engine off after a predetermined time from a prior lubrication event.

As such the vehicle and vehicle system provide advantages over existing HEVs that include dual oil pumps, by eliminating the electric oil pump and thereby saving cost and weight. The vehicle system analyzes the quantity and quality of the oil within the engine block. Based on this analysis, the controller makes an oil maintenance mode request that includes either: restarting the engine if the quality of the oil is insufficient or impure, or backdriving the engine using the generator to drive the oil pump if the quantity of the oil within the engine is not sufficient. Such backdriving of the engine provides engine braking which brakes or decelerates the vehicle. The vehicle system selectively utilizes engine braking to minimize any impact on the regenerative braking capabilities of the vehicle.

### BRIEF DESCRIPTION OF THE DRAWINGS

FIG. 1 is a flowchart illustrating an overview of an oil maintenance monitor for a vehicle according to one or more embodiments;

FIG. 2 is a schematic of a hybrid electric vehicle capable of implementing various embodiments of the present disclosure;

FIG. 3 is a schematic illustrating power flow through the hybrid electric vehicle of FIG. 2 according to various operating modes;

FIG. 4 is a schematic illustrating power flow through the hybrid electric vehicle of FIG. 2 according to an oil maintenance mode, according to one embodiment;

FIG. 5 is a graph illustrating a relationship between a quantity of oil within the engine and the time elapsed since a lubrication event;

FIG. 6 is a flow chart illustrating an oil maintenance monitor for monitoring the quantity of oil within an engine according to one or more embodiments; and

FIG. 7 is a flow chart illustrating an oil maintenance monitor for monitoring the quality of oil within an engine according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

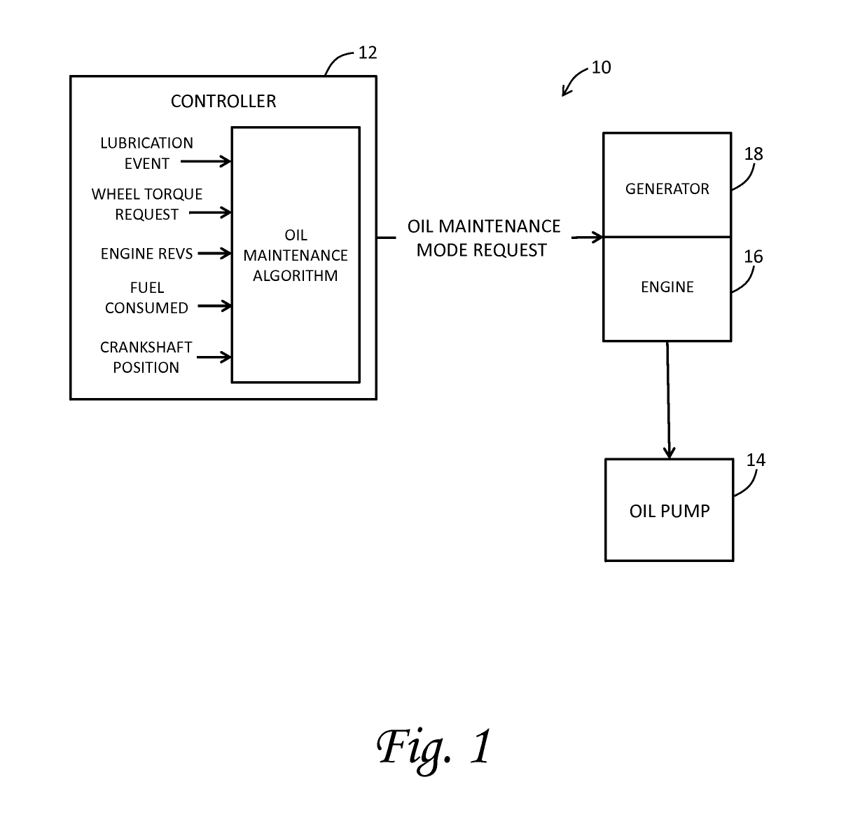

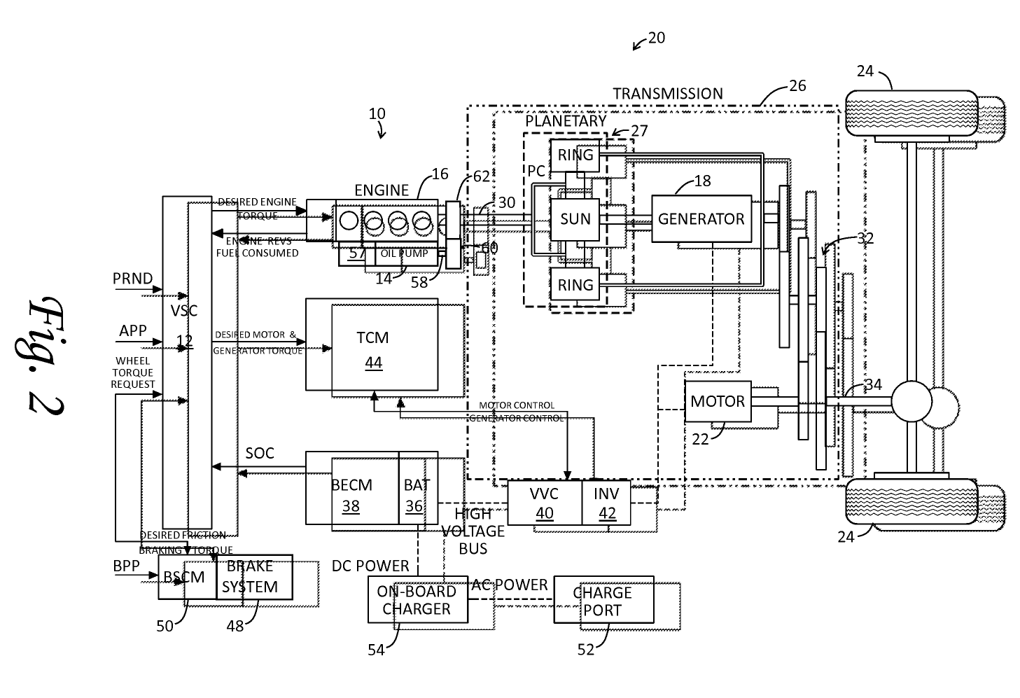

With reference to FIG. 1, a vehicle system for monitoring oil maintenance is illustrated in accordance with one or more embodiments and is generally referenced by numeral 10. The vehicle system 10 includes a controller 12, an oil pump 14 and an engine 16. The oil pump 14 provides lubricating oil to the engine 16 and is driven by the rotation of a crankshaft. The crankshaft rotates during normal engine operation as the engine combusts fuel. The vehicle system 10 also includes a generator 18 that is included in a transmission of the HEV (shown in FIG. 2). The generator 18 is also coupled to the crankshaft and is configured to spin or backdrive the engine 16 when the engine 16 is disabled, or not combusting fuel for driving the oil pump 14.

The controller 12 receives a plurality of input signals that are indicative of a present quantity and quality of the oil within the engine 16. For example, the controller 12 receives input signals: Lubrication Event, Wheel Torque Request, Engine Revs, and Fuel Consumed, that are indicative of: an elapsed time since the oil pump 14 circulated oil through the engine 16; a driver's request for vehicle deceleration that is interpreted as a torque about the wheels; the number of engine revolutions since the last oil change; and the quantity of fuel consumed since the last oil change, respectively. In one or more embodiments the controller 12 also receives input (Crankshaft Position) that is indicative of a current angular position of the crankshaft.

The controller 12 then analyzes the input signals using an oil maintenance algorithm, which is described in greater detail below. Based on this analysis, the controller 12 makes an oil maintenance mode request that includes either: restarting the engine 16, or backdriving the engine 16 using the generator 18. Generally, the controller 12 may maintain normal HEV operation if the quantity and quality of the engine oil is sufficient; the controller 12 may restart the engine 16 if the quality of the engine oil is not sufficient; and the controller 12 may backdrive the engine without fuel, if the quantity of the oil at a location within the engine is not sufficient.

Referring to FIG. 2, the vehicle system 10 is depicted within a plug-in hybrid electric vehicle (PHEV) 20. The vehicle 20 is propelled by two electric machines with assistance from the internal combustion engine 16 and connectable to an external power grid (not shown). The first electric machine is an AC electric motor/generator according to one or more embodiments, and depicted as the “motor” 22 in FIG. 2. The second electric machine is also an AC motor/generator and is depicted as the “generator” 18 in FIG. 2. Both the motor 22 and the generator 18 are configured to function as motors and convert electrical power into mechanical power (drive torque) to drive a pair of wheels 24 for vehicle propulsion. Both the motor 22 and the generator 18 are also configured to function as generators for converting mechanical power from the driven wheels 24 and/or the engine 16 into electrical power through regenerative braking

The vehicle 20 includes a transmission 26 having a power-split configuration, according to one or more embodiments. The transmission 26 includes the motor 22 and the generator 18. The transmission 26 also includes a planetary gear set 27 which includes a sun gear (“SUN”), a planet carrier (“PC”) and a ring gear (“RING”). The ring gear is an outer gear member that circumscribes the sun. A plurality of planet gears are rotatably mounted to the planet carrier such that each planet gear meshes or engages both the ring and the sun. In the illustrated embodiment, the generator 18 is connected to the sun by a generator output shaft 28 and the engine 16 is connected to the planet carrier by a crankshaft 30. The planetary gear set 27 combines the generator power and the engine power and provides a combined output power at the ring gear. The generator 18 and the planetary gear set 27 collectively function as an electronic continuously variable transmission (e-CVT), without any fixed or “step” ratios.

The transmission 26 includes countershaft gears 32 for combining the output power of both the planetary gear set 27 and the motor 22. The countershaft gears 32 include a first gear, a second gear and a third gear, that mesh with a planetary output gear that is connected to the ring gear, a motor output gear that is connected to an output shaft of the motor 22, and a transmission output gear that is connected to a driveshaft 34, respectively. The driveshaft 34 is an output shaft of the transmission 26 and is connected to the pair of driven wheels 24 through a differential.

The vehicle 20 includes an energy storage device, such as a battery 36 for storing electrical energy. The battery 36 is a high voltage battery that is capable of outputting electrical power to operate the motor 22 and the generator 18. The battery 36 also receives electrical power from the motor 22 and the generator 18 when they are operating as generators. The battery 36 is a battery pack made up of several battery modules (not shown), where each battery module contains a plurality of battery cells (not shown). Other embodiments of the vehicle 20 contemplate different types of energy storage devices, such as capacitors and fuel cells (not shown) that may supplement or be used as alternatives to the battery 36. A high voltage bus electrically connects the battery 36 to the motor 22 and the generator 18.

The vehicle 20 also includes a battery energy control module (BECM) 38 for controlling the battery 36. The BECM 38 receives input that is indicative of vehicle conditions and battery conditions, such as battery temperature, voltage and current. The BECM 38 calculates and estimates battery parameters, such as battery state of charge (SOC) and the battery power capability and provides output that is indicative of such parameters to other vehicle systems and controllers.

The vehicle 20 also includes a variable voltage converter (“VVC”) 40 and an inverter 42 according to one or more embodiments. The VVC 40 and the inverter 42 are electrically connected between the battery 36 and the motor 22; and between the battery 36 and the generator 18. The VVC 40 “boosts” or increases the voltage potential of the electrical power provided by the battery 36. The VVC 40 may also “buck” or decrease the voltage potential of the electrical power provided to the battery 36, according to one or more embodiments. The inverter 42 inverts the DC power supplied by the battery 36 (through the VVC 40) to AC power for operating the motor 22 and generator 18. The inverter 42 also rectifies AC power provided by the motor 22 and the generator 18 to DC for charging the battery 36. Other embodiments of the vehicle 20 contemplate multiple inverters (not shown) and/or no VVC.

The vehicle 20 includes a transmission control module (TCM) 44 for controlling the motor 22, the generator 18, the VVC 40 and the inverter 42. The TCM 44 is configured to monitor, among other things, the position, speed, and power consumption of the motor 22 and the generator 18. The TCM 44 also monitors electrical parameters (e.g., voltage and current) at various locations within the VVC 40 and the inverter 42. The TCM 44 provides output signals corresponding to this information to other vehicle systems.

The controller 12 is a vehicle system controller (VSC) that communicates with other vehicle systems and controllers for coordinating their function. Although it is shown as a single controller, the VSC 12 may include multiple controllers that may be used to control multiple vehicle systems according to an overall vehicle control logic, or software.

The vehicle controllers, including the VSC 12, the BECM 38 and the TCM 44 generally include any number of microprocessors, ASICs, ICs, memory (e.g., FLASH, ROM, RAM, EPROM and/or EEPROM) and software code to co-act with one another to perform a series of operations. The controllers also include predetermined data, or “look up tables” that are based on calculations and test data and stored within their memory. The VSC 12 communicates with other vehicle systems and controllers over one or more wired or wireless vehicle connections using common bus protocols (e.g., CAN and LIN). The VSC 12 receives input (PRND) that represents a current position of the transmission 26 (e.g., park, reverse, neutral or drive). The VSC 12 also receives input (APP) that represents an accelerator pedal position. The VSC 12 provides output that represents engine, motor and generator controls based on the input.

The vehicle 20 includes a brake system 48. The braking system 48 includes a brake pedal, a booster, a master cylinder, as well as fluid lines (all not shown) for coupling to the driven wheels 24 to effect friction braking. The braking system 48 also includes position sensors, pressure sensors, or some combination thereof for providing information such as brake pedal position (BPP) that corresponds to a driver request for braking torque.

The vehicle 20 uses engine braking to brake or decelerate the vehicle 20 under certain operating conditions. Engine braking generally refers to the braking effect caused by the closed-throttle partial-vacuum in petrol (gasoline) engines when the accelerator pedal is released. An available engine braking torque corresponds to the size of the engine (e.g., the inertia of any moving components) and whether the engine is currently enabled or disabled. An engine is enabled or running when it is combusting fuel to generate output power. Even if an operator is not depressing the accelerator pedal, the engine is still enabled because the fuel delivery system and the ignition system are still operating, and the engine is idling. An engine is disabled when it is not combusting fuel. The vehicle 20 may still utilize engine braking when the engine 16 is disabled. The generator 18 is coupled to the crankshaft 30 by the planetary gear set 27. Thus, the generator 18 may be controlled to spin or backdrive the engine 16 to effect engine braking, even when the engine 16 is disabled. Such engine braking complements other braking (friction braking and regenerative braking) that is available to the vehicle 20.

The vehicle 20 also includes a brake system control module (BSCM) 50 that communicates with the VSC 12 and the TCM 44 to coordinate regenerative braking, engine braking and friction braking The BSCM 50 provides a wheel torque request input signal to the VSC 12 that corresponds to the brake pedal position (BPP). The VSC 12 then compares the wheel torque request to other vehicle information (e.g., vehicle mass, speed, acceleration, road gradient and battery conditions) to determine a total braking torque value that includes an available regenerative braking torque value, an engine braking torque value and a friction braking torque value. The VSC 12 provides a desired motor torque value and a desired generator torque value to the TCM 44 that corresponds to the regenerative braking torque value and the engine braking torque value, and a desired friction braking torque value to the BSCM 50. In other embodiments, the BSCM 50 determines one or more of the braking torque values.

Generally, the vehicle 20 utilizes regenerative braking as the primary braking source, and supplements with friction braking when there is insufficient available regenerative braking torque to satisfy the wheel torque request. Regenerative braking recharges the main battery 36 and recovers much of the energy that would otherwise be lost as heat during friction braking Therefore regenerative braking improves the overall efficiency or fuel economy of the vehicle as compared to vehicles that are only configured for friction braking Engine braking may be used to supplement friction braking and regenerative braking under limited conditions, e.g., when the wheel torque request is greater than the available regenerative braking toque.

The vehicle 20 is configured as a PHEV according to one or more embodiments. The battery 36 periodically receives AC energy from an external power supply or grid, via a charge port 52. The vehicle 20 also includes an on-board charger 54, which receives the AC energy from the charge port 52. The charger 54 is an AC/DC converter which converts the received AC energy into DC energy suitable for charging the battery 36. In turn, the charger 54 supplies the DC energy to the battery 36 during recharging. Although illustrated and described in the context of a PHEV 20 with a power-split transmission 26, it is understood that embodiments of the vehicle system 10 may be implemented in other types of HEVs having other types of transmissions in which the vehicle may be operated in EV mode for prolonged periods of time.

The vehicle 20 includes an engine control module (ECM) 56 for controlling the engine 16. The VSC 12 provides output (desired engine torque) to the ECM 56 that is based on a number of input signals including APP, and corresponds to a driver's request for vehicle propulsion. The desired engine torque may correspond to a request to start or stop the engine 16. For example, the ECM 56 may stop the engine 16 in response to a desired engine torque of zero Nm. The engine 16 also includes a plurality of sensors for monitoring the present condition of the engine 16, which are collectively represented by numeral 57 in FIG. 2. The sensors 57 monitor the temperature of the engine, the pressure of the engine oil, the speed or revolutions per minute (RPMs) of the engine, and the current angular position of the crankshaft 30. The ECM 56 provides output that corresponds to the information monitored by the sensors to other vehicle controllers, such as the VSC 12.

The oil pump 14 is driven by the crankshaft 30 and circulates oil from an oil sump or oil pan through the engine 16 for lubricating internal moving components (e.g., shafts, pistons, etc.). The oil pump 14 includes an input shaft 58 and an oil pump gear 60 that is fixed to the shaft 58, according to the illustrated embodiment. The oil pump gear 60 engages an engine output gear 62 that is fixed to the crankshaft 30. In other embodiments, the oil pump 14 includes an oil pump pulley that is coupled to a corresponding engine output pulley by a belt (not shown). The oil pump 14 is also coupled to the engine 16 by a fluid circuit (not shown) for providing the oil. Thus, as the crankshaft 30 rotates, it drives the oil pump 14, which in turn circulates oil through the block of the engine 16 to lubricate internal moving components. The crankshaft 30 may be driven by engine power (e.g., internal combustion).

The oil pump 14 may also be driven by the generator 18 when the engine 16 is disabled (i.e. no fuel or spark is provided to the engine 16). The generator 18 is coupled to the crankshaft 30 by the planetary gear set 27. The generator is configured to spin or backdrive the engine 16 when the engine is off, which in turn drives the oil pump 14.

The engine 16 is started or stopped each time the transmission 26 transitions between a HEV mode and an EV mode. In a PHEV, such as the vehicle 20, infrequent restarts of the engine 16 may result in much of the engine oil draining into the oil sump. Restarting the engine 16 when there is insufficient engine oil could increase engine wear due to thin oil films on surfaces between relatively movable elements of the engine, which could potentially affect engine life.

Many prior art HEVs and PHEVs include a secondary engine oil pump that is electrically powered (electric oil pump) to supplement the engine driven oil pump (mechanical oil pump) during the EV mode. However, such a dual oil pump system is redundant, and adds cost and weight to a HEV.

The vehicle system 10 is configured to provide oil to the engine 16 without a secondary electric oil pump. The vehicle system 10 monitors the quantity of oil within the engine 16. If the vehicle system 10 determines that there is insufficient oil within the engine 16, then the vehicle system 10 controls the generator 18 to drive the oil pump 14 and thereby provide the oil to the engine 16. Thus the vehicle system 10 provides cost and weight savings over prior art HEVs having dual oil pump systems.

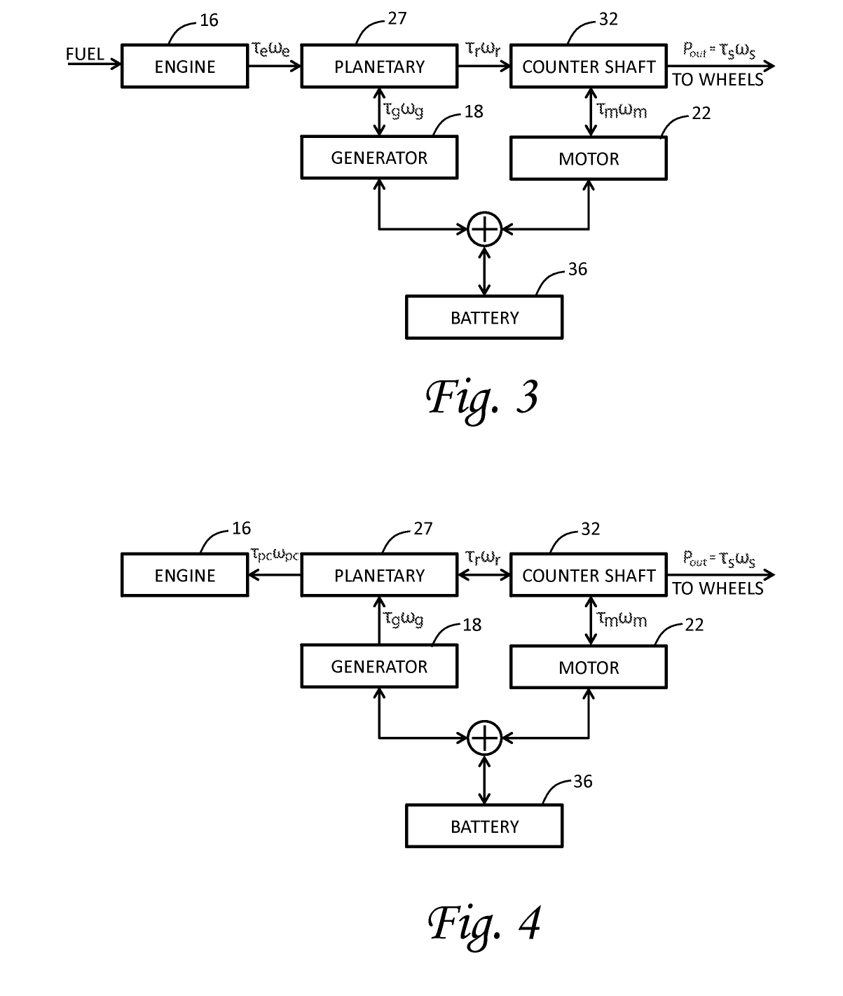

FIG. 3 illustrates the flow of power through the transmission 26 during various operating modes. The engine 16 receives fuel and provides engine power (τₑ,ωₑ) to the planetary gear set 27. The generator 18 provides power (τ_{g},ω_{g}) to the planetary gear set 27 when acting as a motor, and receives power (τ_{g},ω_{g}) when acting as a generator. The ring (r) of the planetary gear set 27 is connected to the countershaft gears 32 for providing power (τᵣ,ωᵣ). The motor 22 provides power (τₘ,ωₘ) to the countershaft gears 32 when acting as a motor, and receives power (τₘ,ωₘ) when acting as a generator. The battery 36 provides electrical power to the generator 18 and the motor 22 when they are acting as motors, and receives electrical power from the generator 18 and the motor 22 when they are acting as generators. The countershaft gears 32 provide output power (Pout=τₛ,ωₛ) to the driven wheels 24 which is based on the power provided by one or more of the engine 16, the motor 22 and the generator 18.

FIG. 4 illustrates the power flow through the transmission 26 when the generator 18 is driving the engine 16 and the oil pump 14 (shown in FIG. 2). The engine 16 is off and not receiving fuel. The generator 18 acts as a motor and provides power (τ_{g},ω_{g}) to the planetary gear set 27. The planet carrier (pc) of the planetary gear set 27 is connected to the engine 16 for providing power (τ_{pc},ω_{pc}). The motor 22 provides power (τₘ,ωₘ) to the countershaft gears 32 when acting as a motor, and receives power (τₘ,ωₘ) when acting as a generator. The battery 36 provides electrical power to the generator 18 and the motor 22 when they are acting as motors, and receives electrical power from the generator 18 and the motor 22 when they are acting as generators. The countershaft gears 32 provide output power (Pout=τₛ,ωₛ) to the driven wheels 24 which is based solely on the power provided by the motor 22. The ring (r) of the planetary gear set 27 is connected to the countershaft gears 32 for receiving power (τᵣ,ωᵣ) to provide a reaction torque while the generator 18 is driving the engine 16.

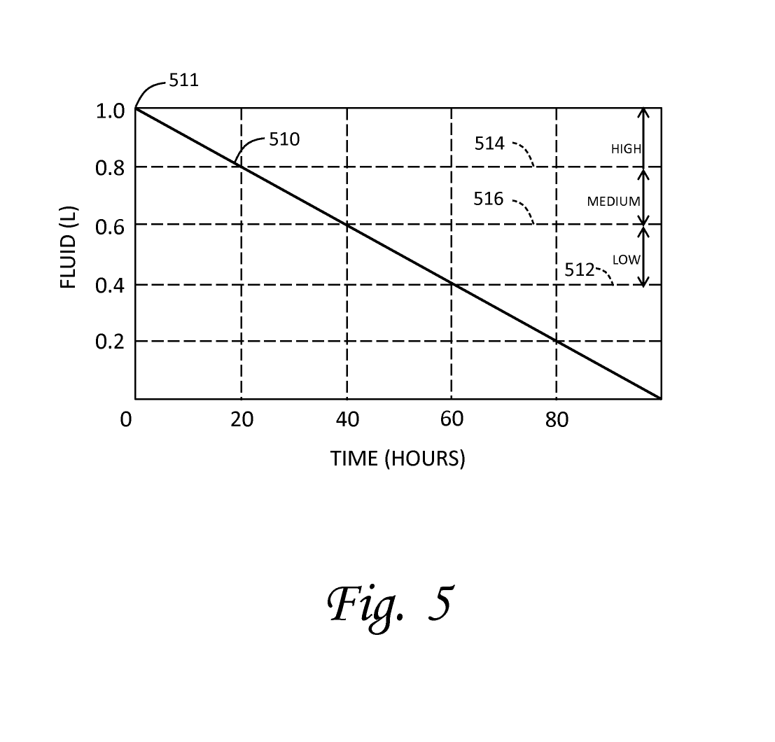

FIG. 5 is a graph illustrating a relationship between a quantity of oil within the engine block and an elapsed time since a lubrication event. The elapsed time includes time when the vehicle is not operating, (e.g., parked or off). This relationship is represented by line 510. The engine oil travels through many small passages or channels that are formed in the engine block and therefore it is difficult to measure the quantity of oil within the engine. However the time since a lubrication event may be used to estimate the quantity of oil within the engine block. A lubrication event occurs when the engine has operated at a predetermined speed for longer than a predetermined period of time to drive the oil pump 14 to sufficiently lubricate the engine 16. For example, in one embodiment, a lubrication event occurs once the engine 16 has operated at idle speed for a short period of time (e.g., five to ten seconds). In one embodiment, the ECM 56 monitors for the occurrence of a lubrication event and resets a timer after each occurrence. Such a reset is represented by point 511 on line 510. In other embodiments, the engine 16 includes a sensor (not shown) for measuring the fluid level within the oil sump. The vehicle system 10 then determines a quantity of oil within the engine block based on both the elapsed time since a lubrication event and the quantity of oil within the oil sump.

To differentiate between engine restart sensitivity with respect to an estimated amount of oil within the engine block, the fluid level range is partitioned into several regions that are defined by predetermined boundaries that are based on the time elapsed since a lubrication event. These boundaries are each represented by horizontal dashed lines that separate the oil quantity operating range into High, Medium and Low oil level regions.

In one embodiment, the engine has an oil capacity of 5.0 L, of which the engine block has a capacity of 1.0 L, and requires a minimum quantity of 0.4 L of oil within the block during engine restart without damaging any internal components. This minimum value corresponds to the amount of oil left in the engine block eighty hours after a lubrication event, and is represented by a Low threshold value 512. Additionally, the engine 16 may be restarted without any potential damage when there is at least 0.8 L of oil in the block. This value corresponds to the amount of oil remaining in the engine block forty hours after a lubrication event, and is represented by a High threshold value 514. Further, the engine 16 may be damaged if restarted numerous times when there is less than 0.6 L of oil in the block. This value corresponds to the amount of oil remaining in the engine block sixty hours after a lubrication event, and is represented by an intermediate threshold value 516. As illustrated in FIG. 5, a region above the high threshold value 514 is designated as a “High” fluid region; a region between the high threshold value 514 and the intermediate threshold value 516 is designated as a “Medium” fluid region; and a region between the medium threshold value 516 and the low threshold value 512 is designated as a “Low” fluid region. The fluid levels provided in this example are merely exemplary and non-limiting, and the threshold values associated with each engine and application will differ.

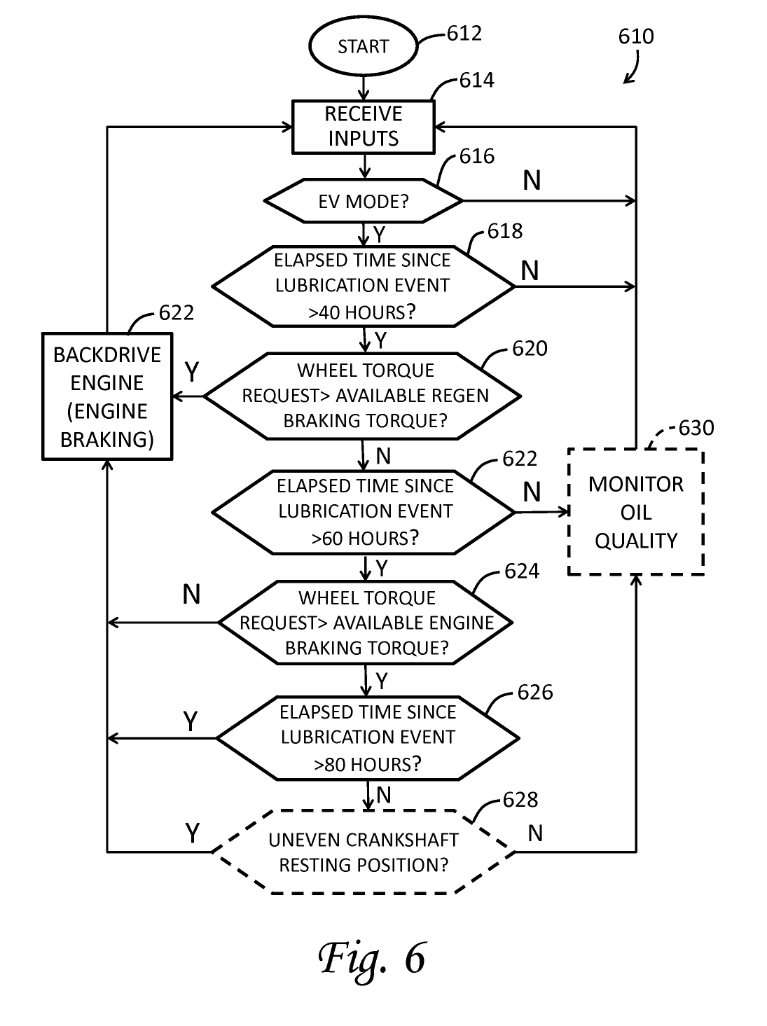

With reference to FIG. 6, an oil maintenance algorithm or method for monitoring a quantity of oil within an engine is illustrated in accordance with one or more embodiments and generally referenced by numeral 610. The method 610 is implemented using software code contained within the VSC 12 according to one or more embodiments. In other embodiments the software code is shared between multiple controllers (e.g., the VSC 12, the ECM 56 and the TCM 44). While the flowchart is illustrated with a number of sequential operations or steps, one or more operations may be omitted and/or executed in another manner without deviating from the scope and contemplation of the present disclosure.

At operation 612 the vehicle system 10 starts or initializes and receives input data and signals including: a current operating mode of the vehicle (Mode), an elapsed time since a lubrication event, a wheel torque request, available regenerative braking torque, and a current crankshaft position.

At operation 616 the vehicle system 10 evaluates the operating mode input to determine if the vehicle 20 is currently operating in an EV mode. If the vehicle 20 is operating in an EV mode, the vehicle system 10 proceeds to operation 618 to determine if the elapsed time since a lubrication event is greater than forty hours. In one embodiment, a lubrication event occurs once the engine has operated at idle speed for a short period of time (e.g., five to ten seconds). If the determination at operation 616 or 618 was negative, then this would indicate that there is a high level of oil within the engine block and the oil level is sufficient for restarting the engine, and therefore the vehicle system returns to operation 614. If the elapsed time since the last lubrication event is greater than forty hours, then the vehicle system proceed to operation 620.

At operation 620 the vehicle system 10 compares the wheel torque request to the available regenerative braking torque. As stated above, the available regenerative braking torque is based on vehicle speed and battery conditions, such as state of charge. If the wheel torque request is greater than the available regenerative torque, then the vehicle system 10 proceeds to operation 622, and drives the crankshaft 30 using the generator 18 to effect engine braking and to drive the oil pump 14 for lubricating the engine 16. As described above, regenerative braking is an important feature for conserving energy within the vehicle 20. Therefore the vehicle system 10 limits any interruption of the regenerative braking. Here since the wheel torque request is greater than the available regenerative braking torque, the vehicle system 10 is not displacing any potentially conserved energy by engine braking. Rather, the vehicle system 10 is displacing friction braking, and thereby helps preserve the friction braking components.

During operation 622 the vehicle system 10 controls the generator 18 to backdrive the engine 16 at approximately idle speeds (e.g., between 500 and 1000 rpms) and limits the duration of such an operation. The vehicle system 10 opportunistically lubricates the engine 16 by driving the crankshaft 30 with the engine off 16, when the high wheel torque request exceeds the available regenerative braking torque, in order to provide lubrication without affecting the regenerative braking efficiency of the vehicle. If the determination at operation 620 is negative, then this would indicate that the vehicle system 10 would limit regenerative braking if it were to use engine braking Therefore the vehicle system proceeds to operation 622 to evaluate additional conditions before performing such engine braking.

At operation 622, the vehicle system 10 determines if the elapsed time since the last lubrication event is greater than sixty hours. If the determination at operation 622 is negative, then this would indicate that it has been somewhere between forty and sixty hours since the last lubrication event. The quantity of oil within the engine block is within the medium region and sufficient for a restart, and therefore the vehicle system 10 will delay engine braking The vehicle system 10 then returns to operation 614. If the elapsed time since the last lubrication event is greater than sixty hours, then the vehicle system proceeds to operation 624.

At operation 624 the vehicle system compares the wheel torque request to the available engine braking torque. If the wheel torque request is less than or equal to the available engine braking torque, then this would indicate that if engine braking were applied then the deceleration of the vehicle would be greater than that desired by the driver, and this would likely be perceptible to the driver. However, if the wheel torque request is greater than the available engine braking torque the vehicle system 10 proceeds to operation 622 and applies engine braking If the determination at operation 624 is negative, the vehicle system 10 proceeds to operation 626.

At operation 626 the vehicle system 10 determines if the elapsed time since the last lubrication event is greater than eighty hours. After eighty hours, an engine restart may damage the engine. Therefore, if the elapsed time is greater than eighty hours the vehicle system 10 proceeds to operation 622 and applies engine braking Such engine braking will likely be perceptible to the driver because they have not requested such vehicle deceleration. Therefore, in one or more embodiments the vehicle system 10 communicates the low engine oil/engine braking status to the driver via a user interface such as a display or audio message (not shown). If the determination at operation 626 is negative, the vehicle system 10 returns to operation 614.

In one or more embodiments, the method 610 also includes optional operations for monitoring the condition of engine components and for monitoring the quality of the oil within the engine 628. The vehicle system 10 may proceed to optional operation 628 in response to a negative determination in operation 626.

At operation 626 the vehicle system 10 compares the current angular position of the crankshaft 30 to historical information regarding prior resting angular positions of the crankshaft 30. If the current angular position of the crankshaft is “uneven” or a position in which the crankshaft 30 has rested for an unproportional length of time as compared to other positions, then the vehicle system 10 will proceed to operation 622 and backdrive the engine 16. A crankshaft 30 may wear unevenly, if the crankshaft 30 rests in the same general angular position for a prolonged period of time. This is due to the crankshaft 30 rocking slightly back and forth during EV mode. Although, it may be difficult for the vehicle system 10 to precisely stop the engine crankshaft at a specific angular position, such an operation may help to avoid uneven wear.

The vehicle system 10 may proceed to optional operation 630 in response to a negative determination at operations 622, 626 or 628. Generally, at operation 628 the vehicle system evaluates input signals that correlate to the quality of the oil within the engine. If the quality of the oil is low and there is sufficient oil within the engine block, then the vehicle system 10 may restart the engine 16 to improve the quality.

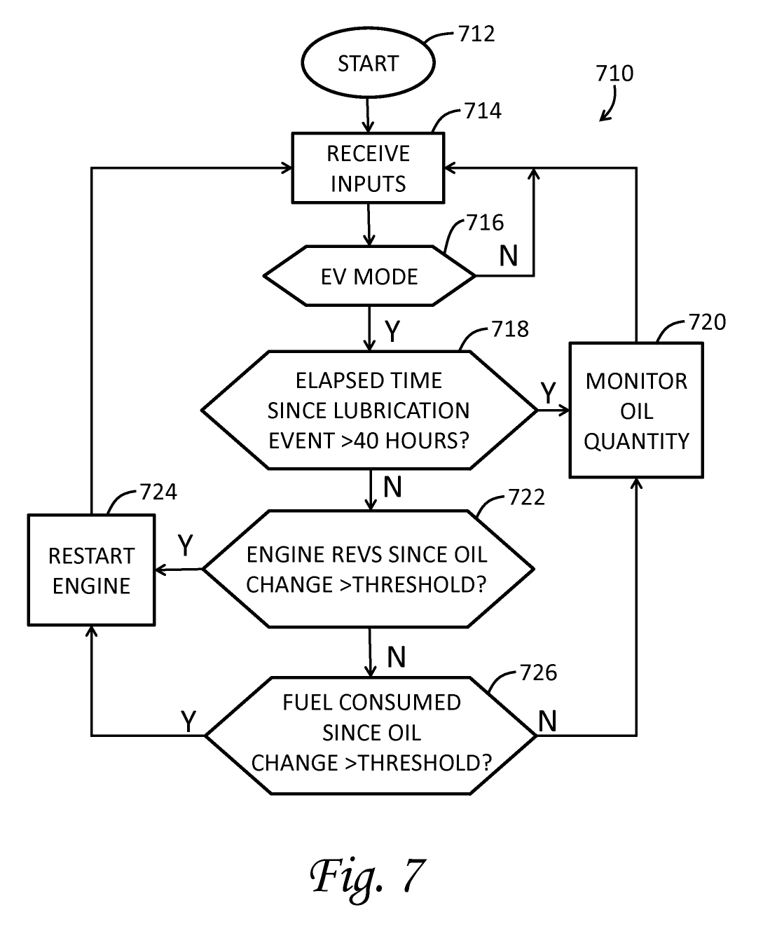

With reference to FIG. 7, an oil maintenance algorithm or method for monitoring the quality of oil within an engine is illustrated in accordance with one or more embodiments and generally referenced by numeral 710. The method 610 is implemented using software code contained within the VSC 12 according to one or more embodiments. In other embodiments the software code is shared between multiple controllers (e.g., the VSC 12, the ECM 56 and the TCM 44). While the flowchart is illustrated with a number of sequential steps, one or more steps may be omitted and/or executed in another manner without deviating from the scope and contemplation of the present disclosure. In one or more embodiments the method 710 is included within operation 628 of method 610.

At operation 712 the vehicle system 10 starts or initializes and receives input data and signals including: a current operating mode of the vehicle (Mode), an elapsed time since a lubrication event, the number of engine revolutions since the last oil change, and the amount of fuel consumed since the last oil change.

At operation 716 the vehicle system 10 evaluates the operating mode input to determine if the vehicle 20 is currently operating in an EV mode. If the vehicle 20 is operating in an EV mode, the vehicle system 10 proceeds to operation 718 to determine if the elapsed time since a lubrication event is greater than forty hours. If the determination at operation 718 is positive, the vehicle system 10 proceeds to operation 720 to monitor the quantity of oil within the engine block. In one or more embodiments, operation 720 corresponds with the method 610 of FIG. 6. If the elapsed time since a lubrication event is less than forty hours, the vehicle system 10 proceeds to operation 722.

At operation 722 the vehicle system 10 compares the number of engine revolutions since the last oil change to a predetermined revolution value. If the number exceeds the predetermined revolution value this would indicate that the oil is stale and may contain impurities (e.g., water and fuel). To remove such impurities, the vehicle system 10 proceeds to operation 724 and restarts the engine 16. If the determination at operation 722 is negative, then the vehicle system proceeds to operation 726 and compares the amount of fuel consumed since the last oil change to a predetermined fuel consumption value. If the number exceeds the predetermined fuel consumption value, then this would indicate that the oil is stale and may contain impurities (e.g., water and fuel). To remove such impurities, the vehicle system 10 proceeds to operation 724 and restarts the engine 16.

As such the vehicle system 10 provides advantages over existing HEVs that include dual oil pumps, by eliminating the electric oil pump and thereby saving cost and weight. The vehicle system 10 also provides advantages over other systems that may include additional sensors for monitoring the engine 16. The vehicle system 10 monitors the quantity and quality of the oil within the engine block using existing sensors, and analyzes this information using an oil maintenance algorithm. Based on this analysis, the controller 12 makes an oil maintenance mode request that includes either: restarting the engine 16 if the quality of the oil is insufficient or impure, or backdriving the engine 16 using the generator 18 to drive the oil pump 14 if the quantity of the oil within the engine is not sufficient. Such backdriving of the engine provides engine braking which brakes or decelerates the vehicle 20. The vehicle system 10 selectively utilizes engine braking to minimize any impact on the regenerative braking capabilities of the vehicle 20.

While the best mode has been described in detail, those familiar with the art will recognize various alternative designs and embodiments within the scope of the following claims. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A hybrid vehicle comprising:
an engine having a crankshaft;
an electric machine coupled to the crankshaft;
a pump driven by rotation of the crankshaft and coupled to the engine by a fluid circuit; and
a controller configured to control the electric machine in response to a wheel torque request to drive the crankshaft with the engine off to provide lubricant to the engine.

2. The hybrid vehicle of claim 1 wherein the controller is further configured to control the electric machine to drive the crankshaft in response to the wheel torque request exceeding an available regenerative braking torque and an elapsed time since a lubrication event exceeding a first time threshold.

3. The hybrid vehicle of claim 1 wherein the controller is further configured to control the electric machine to drive the crankshaft for providing lubrication fluid to the engine in response to the wheel torque request exceeding an available engine braking torque and an elapsed time since a lubrication event exceeding a second time threshold.

4. The hybrid vehicle of claim 1 wherein the controller is further configured to control the electric machine to drive the crankshaft in response to an elapsed time since a lubrication event exceeding a third time threshold.

5. The hybrid vehicle of claim 1 further comprising a second electric machine, and wherein the controller is further configured to control the second electric machine to provide drive torque for vehicle propulsion in response to controlling the electric machine to drive the crankshaft with the engine off.

6. The hybrid vehicle of claim 1 wherein the controller is further configured to control the engine to restart in response to an elapsed time since a lubrication event being less than a first time threshold and a number of engine revolutions since an oil change exceeding a revolution threshold.

7. The hybrid vehicle of claim 1 wherein the controller is further configured to control the engine to restart in response to an elapsed time since a lubrication event being less than a first time threshold and an amount of fuel consumed since an oil change exceeding a consumption threshold.

8. A method for providing lubrication fluid to an engine in a hybrid vehicle, the method comprising:
disabling fuel provided to an engine; and
controlling an electric machine to drive a crankshaft of the engine and a pump coupled to the crankshaft in response to a wheel torque request exceeding an available regenerative braking torque, wherein the pump is coupled to the engine for providing lubrication fluid.

9. The method of claim 8 further comprising controlling the electric machine to drive the crankshaft in response to an elapsed time since a lubrication event exceeding a first time threshold and the wheel torque request exceeding the available regenerative braking torque.

10. The method of claim 9 further comprising controlling the electric machine to drive the crankshaft in response to the wheel torque request exceeding an available engine braking torque and the elapsed time since a lubrication event exceeding a second time threshold, wherein the second time threshold is greater than the first time threshold.

11. The method of claim 10 further comprising controlling the electric machine to drive the crankshaft in response to the elapsed time since a lubrication event exceeding a third time threshold, wherein the third time threshold is greater than the second time threshold.

12. The method of claim 8 further comprising controlling the electric machine to drive the crankshaft in response to a current position of the crankshaft being within a range of historically high resting positions of the crankshaft.

13. A vehicle system comprising:
a pump coupled to a crankshaft of an engine to provide lubricant thereto in response to rotation of the crankshaft; and
a controller configured to control an electric machine to drive the crankshaft with the engine off after a predetermined time from a prior lubrication event.

14. The vehicle system of claim 13 wherein the controller is further configured to control an electric machine to drive the crankshaft with the engine off after a second predetermined time from the lubrication event and in response to a wheel torque request exceeding an available engine braking torque, wherein the second predetermined time is less than the predetermined time.

15. The vehicle system of claim 14 wherein the controller is further configured to control an electric machine to drive the crankshaft with the engine off after a first predetermined time from the lubrication event and in response to a wheel torque request exceeding an available regenerative braking torque, wherein the first predetermined time is less than the second predetermined time.

16. The vehicle system of claim 13 wherein the controller is further configured to control an electric machine to drive the crankshaft in response to a wheel torque request exceeding an available regenerative braking torque.

17. The vehicle system of claim 13 wherein the controller is further configured to control the electric machine to drive the crankshaft in response to a current position of the crankshaft being within a range of historically high resting positions of the crankshaft.

18. The vehicle system of claim 13 wherein the controller is further configured to control the engine to restart in response to an elapsed time since a lubrication event being less than a first predetermined time and a number of engine revolutions since an oil change exceeding a revolution threshold.

19. The vehicle system of claim 13 wherein the controller is further configured to control the engine to restart in response to an elapsed time since a lubrication event being less than a first predetermined time and an amount of fuel consumed since an oil change exceeding a consumption threshold.

20. The vehicle system of claim 13 wherein the controller is further configured to identify an occurrence of a lubrication event and reset an associated timer in response to the engine rotating at idle speed for over five seconds.
